(19) United States
(12) Patent Application Publication
(10) Pub. No.: US 2024/0368423 A1
(43) Pub. Date: Nov. 7, 2024

(54) REFLECTIVE ROOF COATING HAVING REDUCED TITANIUM DIOXIDE

(71) Applicant: MiRus LLC, Marietta, GA (US)

(72) Inventors: David Sokol, Vermillion Township, OH (US); Jason D. Smith, Strongsville, OH (US)

(21) Appl. No.: 18/435,262

(22) Filed: Feb. 7, 2024

Related U.S. Application Data
(60) Provisional application No. 63/463,968, filed on May 4, 2023.
(60) Provisional application No. 63/601,347, filed on Nov. 21, 2023.

(51) Int. Cl. C09D 133/04; C09D 5/18; C09D 7/40; C09D 7/41; C09D 7/61; C09D 7/65; E04D 1/00; E04D 1/22; E04D 5/12

(52) U.S. Cl. CPC C09D 133/04; C09D 5/18; C09D 7/41; C09D 7/61; C09D 7/65; C09D 7/67; C09D 7/68; C09D 7/70; E04D 1/22; E04D 5/12; E04D 2001/005

(57) ABSTRACT

A reflective coating that is substantially or fully absent of TiO₂, and which coating is capable of meeting the ASTM D6083 specification for acrylic roof coatings, and which coating has suitable hide to achieve an average resulting solar reflectively of at least 60% or an SRI of at least 60.

### REFERENCED APPLICATIONS

The present application claims priority to U.S. Provisional Application Ser. No. 63/463,968 filed May 4, 2023, which is fully incorporated herein by reference.

The present application claims priority to U.S. Provisional Application Ser. No. 63/601,347 filed Nov. 21, 2023, which is fully incorporated herein by reference.

### FIELD OF DISCLOSURE

The present disclosure relates to roofing and/or siding materials, particularly to improved roofing and/or siding materials having increased reflectivity, more particularly to a reflective coating that is substantially or fully absent of TiO₂ and which coating is capable of meeting the ASTM D6083 specification for acrylic roof coatings, even more particularly to a reflective coating that is substantially or fully absent of TiO₂ and which coating is capable of meeting the ASTM D6083 specification for acrylic roof coatings and which coating has suitable hide power to achieve an average resulting solar reflectively of at least 60% or an SRI of at least 60, and still yet even more particularly to a reflective coating that is fully absent of TiO₂ and which coating is capable of meeting the ASTM D6083 specification for acrylic roof coatings and which coating has suitable hide power to achieve an average resulting solar reflectively of at least 60% or an SRI of at least 60, and while at the same time reducing the density of the product in packaging.

### INCORPORATION BY REFERENCE

U.S. Pat. Nos. 2,379,358; 3,255,031; 3,479,201; 3,528,842; 4,120,132; 4,288,959; 4,478,869; 5,088,259; 5,474,838; 5,540,971; 5,573,810; 5,695,373; 5,813,176; 5,965,626; 6,110,846; 6,194,519; 6,207,593; 6,296,912; 6,296,921; 6,341,462; 6,360,511; 10,626,615; 10,597,555; 11,433,366; 11,427,507; 11,371,244; and 11,453,614 are incorporated herein by reference to illustrate various types of roofing and/or siding systems on which the granular material of the present disclosure can be used, to also illustrate various manufacturing techniques for making such roofing and/or siding systems, and/or to further illustrate various types of prior art granules.

### BACKGROUND OF DISCLOSURE

So called “cool roof coatings” have been utilizing titanium dioxide (TiO₂) because of the superior hiding power at relatively low loadings. In 2019, the International Agency for Research on Cancer (IARC) classified TiO₂ as an IARC Group 2B carcinogen, or “possibly carcinogen to humans”. Because of TiO₂'s unparalleled hiding power, finding a suitable substitute among the available pigments and extenders that are still considered non-hazardous is difficult without having a negative effect on the surface reflectance, emittance, and solar reflective index (SRI). Also, care needs to be taken to find the right pigment volume concentration (PVC) that will not take away from the short-term and long-term properties that the American Society for Testing and Materials (ASTM) specification for roof coatings, namely ASTM D6083 and/or D6694, specify.

Although the color of a particular roofing system plays an important role in determining which roofing system will be purchased by consumers, other factors are also of importance in determining the color of a particular roofing system. One such factor is the energy efficiency of the roofing system. Several cities and states are beginning to consider legislation or currently require some roofing structures to have a certain resulting reflectivity. This is of particular importance in temperate regions, such as in the Southern and Southwest regions of the United States. Lighter colored roofs are known to reduce the roof temperature, thereby reducing the cooling costs of the roofed structure. The cooler temperature of the light-colored roof system not only reduces the cooling costs associated with the building, but the heat generated by the light-colored roof contributes less heat to the surrounding environment, thus improving air quality, especially in urban areas.

Typical light colored roofing systems have light colored granules having a reflectivity of up to 30% and a resulting roofing reflectivity of up to 27%. Darker colored granules typically have a lower reflectivity and a resulting roofing reflectivity that is less than roofing systems having lighter colored granules. The bitumen layer on the roofing system is a generally black color, thus has a low reflectivity. When coating the bitumen layer with lighter colored or reflective particles, some of the bitumen surface remains exposed, thus reducing the resulting reflectivity of the roofing system.

One practice for obtaining a highly reflective surface on a roofing system is to apply a film of highly reflective coating to the surface of the installed roofing system. Typically, a coating with thickness of about 5 dry mils or more was applied after the roofing system is installed on a structure. The application of a highly reflective coating layer on the existing roof system can be used to achieve a resulting solar reflectivity of 70% or greater. Common white colored coatings include titanium dioxide (TiO₂) as the primary pigment component. Because of TiO₂ unparalleled hiding properties and white pigment properties, finding a suitable a substitute among the available pigments and extenders that are still considered non-hazardous has been difficult without creating a negative effect on the solar reflectance, thermal emittance, and Solar Reflective Index (SRI) of the coating. Also, care needs to be taken to find the right pigment volume concentration that will not take away from the long-term properties that these roof coatings need to possess for the exterior environmental conditions that the coating will be exposed.

Prior attempts have been made to formulate a materials that have reduced TiO₂ without affecting the solar reflectivity, emittance, or SRI (See U.S. Pat. Nos. 10,633,869; 10,280,626; 9,636,706; US 2021/0403726; US 2021/0071010; US 2018/0244928; US 2018/0180331; US 2017/0073530; WO 2022/252281; WO 2020/072818; WO 2019/110872; WO 2011/045740; WO 2009/100510; WO 2008/147972; WO 2006/024959; WO 95/10569; AU 2010249301; CA 3096564; CN 115433516; CN 114760846; CN 109705723; DE 202017104644; DE 102020006913; DE 102018118285; EP 4098629; EP 4001363; EP 0454349; FR 3132104; FR 3105028; IN 0011/MUM/2004; JP 2023531836; and JP 2022549359 (all of which are fully incorporated herein by reference); however, such coatings have unacceptable properties with regard to flexibility a cracking, thus cannot be used to form satisfactory coatings for roofing and siding applications because they do not meet the ASTM D6083 specification for liquid applied acrylic roof coatings.

In view of the continued demand for greater energy savings, there is a demand for an improved coating that is substantially or fully absent TiO₂, and which coating can be used to for a roofing system having increased reflectivity.

### SUMMARY OF DISCLOSURE

The present disclosure relates to roofing and/or siding materials, particularly to an improved roof coating that is substantially absent of TiO₂ (e.g., coating contains less than 2 wt. % TiO₂) or is absent (coating contains 0 wt. % TiO₂) of TiO₂, and particularly to an improved roof coating that is substantially absent of TiO₂ (e.g., coating contains less than 2 wt. % TiO₂) or is absent (coating contains 0 wt. % TiO₂) of TiO₂, with coating meets ASTM D6083 standards for coating, and the use of such roof coating on the roofing and/or siding materials improves the reflectivity on the coated surface of the roofing and/or siding material. The present disclosure is applicable to many types of roofing and/or siding materials including, but not limited to, shingles, cap sheet roll roofing, modified bitumen, foam roofing, built-up roofing (BUR), metal roofing and/or siding, plastic roofing and/or siding, flood coat and gravel systems, and wood roofing and/or siding. As can be appreciated, the present disclosure has a broader scope in that the improved coating that is substantially or fully absent TiO₂ can be used in other applications such as, but not limited to, coatings used on streets, sidewalks, parking lots, driveways, runways, steps, landscape stones, statues, coating for interior and/or exterior surface of building structures, and other types of structures. In one non-limiting embodiment, the improved coating that is substantially or fully absent TiO₂ can be applied to prefabricated roofing systems such as, but not limited to, shingles, cap sheet roll roofing, modified bitumen, metal roofing and/or siding, plastic roofing and/or siding, and wood roofing and/or siding wherein the roofing materials are manufactured off-site and then subsequently installed on a roof and/or siding of a building or other type of structure. In another non-limiting embodiment, the improved coating that is substantially or fully absent TiO₂ can applied after a roof material has been applied to a roofing substrate. In such an embodiment, the improved coating that is substantially or fully absent TiO₂ can be spray coated, roll coated, brush coated, etc. onto the top surface of the roof material (e.g., shingles, cap sheet roll roofing, modified bitumen, foam roofing, built-up roofing (BUR), metal roofing and/or siding, plastic roofing and/or siding, flood coat and gravel systems, and wood roofing and/or siding, etc.).

Roofing and/or siding shingles and cap sheet roll roofing and/or siding usually employ a web of fibrous base material. The base material typically is a nonwoven fabric such as, but not limited to, felt (organic, glass fiber, polyester, polypropylene, etc.), fiberglass, or similar materials, which are commonly coated with a material. One non-limiting material is a bituminous composition such as, but not limited to, bitumens, modified bitumens, tars, pitches, asphalt, and the like. As can be appreciated, other types of coatings (e.g., polymers, etc.) can be used as an alternative coating or in conjunction with a bituminous composition. A solid material such as, but not limited to, granules or slag are then pressed into the layer of bituminous composition while it is in a warm, softened condition. Upon cooling, the solid material remains attached as a surface layer of bituminous composition. Finely divided materials such as, but not limited to, mica flakes, talc, silica dust or the like can be applied and/or made adherent to the non-weather exposed surface of the shingle to prevent sticking of the adjacent layers of the material when placed in packages or shipment or storage. Non-limiting examples of shingles are disclosed in U.S. Pat. Nos. 6,194,519; 6,296,912; and 6,341,462, which are fully incorporated herein by reference. These shingles or a modified version of these shingles can be formed by the manufacturing process of the present disclosure to form reflective shingles. The process of the present disclosure can be used to form such shingles off-site at a manufacturing facility and then have such shingles delivered to a construction-site for installation of a building or other type of structure. As can be appreciated, the shingles can be coated with the improved coating that is substantially or fully absent TiO₂ after the shingles have been applied to a roof and/or siding of a structure.

Modified bitumen materials incorporate the use of a composite fabric that is at least partially impregnated with a bituminous composition. The composite fabric typically includes, but is not limited to, a layer of woven or nonwoven material connected to one or more layers of low shrinkage warp strands and/or one or more layers of low shrinkage weft strands. Similar to shingles, the composite fabric is coated with coating material such as, but not limited to a bituminous material and then commonly coated with a solid material such as, but not limited to, granules or slag that are then at least partially pressed into the layer of bituminous material while it is in a warm, softened condition. Non-limiting examples of modified bitumen materials are disclosed in U.S. Pat. Nos. 5,474,838; 5,540,971; 5,695,373; 6,296,921, which are fully incorporated herein by reference. These modified bitumen materials or a modified version of these materials can be formed by the manufacturing process of the present disclosure to form a reflective modified bitumen material. The process of the present disclosure can be used to form such materials off-site at a manufacturing facility and then have such materials delivered to a construction-site for installation of a building or other type of structure. As can be appreciated, the modified bitumen materials can be coated with the improved coating that is substantially or fully absent TiO₂ after the modified bitumen materials have been applied to a roof and/or siding of a structure.

Metal, plastic and wood roofing and/or siding have also been coated with solid material such as, but not limited to, granules or slag to provide texture, color and/or improved durability. Typically, the solid material is adhered to the metal, plastic and/or wood roofing and/or siding by the use of an adhesive such as, but not limited to, polymer adhesives, glue, bitumen, asphalt, etc. Non limiting examples of metal, plastic and/or wood roofing and/or siding are disclosed in U.S. Pat. Nos. 4,120,132 and 4,288,959, which are fully incorporated herein by reference. These metal, plastic and/or wood roofing and/or siding systems or a modified version thereof can incorporate the forming process of the present disclosure to form a highly reflective metal, plastic and/or wood roofing and/or siding system. As can be appreciated, the metal, plastic and/or wood roofing and/or siding systems can be coated with the improved coating that is substantially or fully absent TiO₂ after the metal, plastic and/or wood roofing and/or siding systems have been applied to a roof and/or siding of a structure.

In one non-limiting aspect of the present disclosure, there is provided a roofing and/or siding system that includes and/or is coated with an improved coating that is substantially or fully absent TiO₂ and which roofing and/or siding system has improved resulting reflectivity. In one non-limiting embodiment, the roofing and/or siding system that includes and/or is coated with an improved coating that is substantially or fully absent TiO₂ has a) a resulting reflectivity of at least about 60% (e.g., 60%-98% and all values and ranges therebetween) as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of at least 60 (e.g., 60-98 and all values and ranges therebetween) in accordance with ASTM E1980. In another non-limiting embodiment, the roofing and/or siding system that includes and/or is coated with an improved coating that is substantially or fully absent TiO₂ has a) a resulting reflectivity of at least about 70%; and/or b) a Solar Reflectance Index (SRI) of at least 70. The improved reflectivity of the roofing and/or siding system provides several benefits to the roofing and/or siding system, namely a) reduces the temperature of the surface of the roofing and/or siding system, especially on warm, sunny days, b) reduces the amount of heat transfer from the surface of the roofing and/or siding system to the structure positioned adjacently the roofing and/or siding system, c) reduces the contribution of the roofing and/or siding system as an urban heat island, which can have negative effect on air quality in urban areas, e) increases the life of the roofing and/or siding system, and/or f) reduces the amount of sunlight that penetrates into the surface of the roofing and/or siding system, thus enabling the roofing system to be classified as a “cool roof”.

In another non-limiting and/or alternative aspect of the present disclosure, the roofing and/or siding system includes one or more coatings of the improved coating that is substantially or fully absent TiO₂, and which improved coating that is substantially or fully absent TiO₂ has a) a resulting reflectivity of at least about 60% (e.g., 60%-98% and all values and ranges therebetween); and/or b) a Solar Reflectance Index (SRI) of at least 60 (e.g., 60-98 and all values and ranges therebetween). One or more layers of the improved coating that is substantially or fully absent TiO₂ can be applied to the roofing and/or siding system at the time the rooking materials are manufactured and/or after the roofing materials are applied to the roof substrate. In one non-limiting embodiment, the improved coating that is substantially or fully absent TiO₂ can be a solvent-based coating, a latex-based coating, an acrylic-based coating, a vinyl-acrylic based coating, a polyurethane base coating, a polyurea-based coating, a silicone-based coating, a silicon hybrid based coating, polyvinyl alcohol-based coating, polydimethylsiloxane-based coating, PMMA-based coating, PUMA-based coating, SEBS elastomeric based coating, alkyd-based coating, epoxy-based coating, or a Polyvinylidene Fluoride (PVDF) based coating. In another non-limiting embodiment, the one or more coatings of the improved coating that is substantially or fully absent TiO₂ can be applied by a) a spraying process, b) a dipping process, and/or c) use of a brush, a sponge, squeegee, and/or a mop. The application of the one or more layers of the improved coating that is substantially or fully absent TiO₂ on the roofing system can be used to only increase the resulting reflectivity and/or Solar Reflectance Index (SRI) of the roofing and/or siding system, the one or more layers of the improved coating that is substantially or fully absent TiO₂ can be used to a) fill in the uncovered regions of the roofing and/or siding system and spaces between the solid material on the roofing and/or siding material thereby reducing the amount of exposure of the low reflective materials (e.g., asphalt, bitumen, etc.), b) fill in the spacing between the solid material to form a more smooth roofing surface, which smoother surface can be more aesthetically pleasing and/or increase the effective reflectivity of the roofing and/or siding system, c) improve the bonding of the one or more layers of solid material to the roofing and/or siding system, d) increase the strength and/or durability of the roofing/and/or siding system, and/or e) provide additional sealing and/or insulative properties of the roofing and/or siding system. In another non-limiting embodiment, improved coating that is substantially or fully absent TiO₂ has a generally white color; however, it will be appreciated that the coating can be formulated to have other colors (e.g., grey, black, brown, etc.). In another non-limiting embodiment, the improved coating that is substantially or fully absent TiO₂ has a coating thickness of at least about 0.5 mils (e.g., 0.5-1000 mils and all values and ranges therebetween).

In another non-limiting and/or alternative aspect of the present disclosure, the roofing and/or siding system includes one or more coatings of the improved coating that is substantially or fully absent TiO₂, and which roofing and/or siding system meets one or more or all of the ASTM D6083 standard for liquid applied acrylic coating. The ASTM D6083 standard for an acrylic roof coating is as follows:

| | Requirement | |
|---|---|---|
| | Type I | Type II |
| Initial Percent Elongation (Break) | min. 100% 23° C. [73° F.] | min. 100% 23° C. [73° F.] |
| Initial Tensile Strength | min. 1.4 MPa [200 psi] | min. 1.4 MPa [200 psi] |
| (Max Stress) | 23° C. [73° F.] | 23° C. [73° F.] |
| Final Percent Elongation | min. 100% at 23° C. [73° F.] | min. 100% at 23° C. [73° F.] |
| (Break after Accelerated Weathering | | |
| 1000 h) | | |
| Permeance | max. 2875 ng [Pa · s · m²] | max. 2875 ng [Pa · s · m²] |
| | [50 Perms] | [50 Perms] |
| Water Swelling | max. 20% (mass) | max. 20% (mass) |
| Accelerated Weathering | No cracking or checking | No cracking or checking |
| 1000 h | | |
| Fungi Resistance | 0 Rating | 0 Rating |
| Tear Resistance | >21.0 kN/m [60 lbf/in] | >21.0 kN/m [60 lbf/in] |
| Low Temperature Flexibility after | min. pass 13 mm [0.5 in] | min. pass 13 mm [0.5 in] |
| 1000h Accelerated Weathering | mandrel −26° C. [−15° F.] | mandrel −10° C. [−14° F.] |

In one non-limiting embodiment, the improved coating that is substantially or fully absent TiO₂ has physical properties, when dried, satisfies a) the Initial Percent Elongation (Break) and/or b) Initial Tensile Strength (Max Stress) requirements of the ASTM D6083 standard. In another non-limiting embodiment, the improved coating that is substantially or fully absent TiO₂ has physical properties, when dried, satisfies a) the Initial Percent Elongation (Break), b) Initial Tensile Strength (Max Stress), c) the Final Percent Elongation (Break after Accelerated Weathering 1000h), and/or d) the Permeance requirements of the ASTM D6083 standard. In another non-limiting embodiment, the improved coating that is substantially or fully absent TiO₂ has physical properties, when dried, satisfies a) the Initial Percent Elongation (Break), b) Initial Tensile Strength (Max Stress), c) the Final Percent Elongation (Break after Accelerated Weathering 1000h), d) the Permeance, e) Water Swelling-max. 20% (mass), f) Accelerated Weathering 1000h, g) Tear Resistance, and/or h) Low Temperature Flexibility after 1000h Accelerated Weathering requirements of the ASTM D6083 standard.

In another non-limiting and/or alternative aspect of the present disclosure, the improved coating that is substantially or fully absent TiO₂ includes a pigment that includes one or more of BaSO₄, ZnO, and/or ZnS. As defined herein, a coating that is substantially absent TiO₂ is a coating that includes no more than 10 wt. % TiO₂ (e.g., 0-10 wt. % and all values and ranges therebetween). In one non-limiting embodiment, the weight percent of the pigment of the coating that includes BaSO₄, ZnO, and/or ZnS and which is substantially or fully absent TiO₂ is at least 0.1 wt. % (e.g., 0.1-50 wt. % and all values and ranges therebetween). In another non-limiting embodiment, the weight percent of the pigment of the coating that includes BaSO₄, ZnO, and/or ZnS and which is substantially or fully absent TiO₂ is 0.1-35 wt. %. In another non-limiting embodiment, the weight percent of the pigment of the coating that includes BaSO₄, ZnO, and/or ZnS and which is substantially or fully absent TiO₂ is 0.2-10 wt. %. In another non-limiting embodiment, the weight percent of the pigment of the coating that includes BaSO₄, ZnO, and/or ZnS and which is substantially or fully absent TiO₂ is 0.5-5 wt. %.

In another non-limiting and/or alternative aspect of the present disclosure, the improved coating that is substantially or fully absent TiO₂ includes a pigment other than TiO₂ (e.g., BaSO₄, ZnO, and/or ZnS) and an optional pigment extender. The optional use of pigment extender can be used to further improve the hiding power of the coating in the absence of TiO₂. In one non-limiting embodiment, the improved coating that is substantially or fully absent TiO₂ includes a pigment (e.g., BaSO₄, ZnO, and/or ZnS) and a pigment extender, and a wherein a combined weight percent of the pigment and pigment extender is 0.2-65 wt. % (and all values and ranges therebetween). In another non-limiting embodiment, the improved coating that is substantially or fully absent TiO₂ includes a pigment (e.g., BaSO₄, ZnO, and/or ZnS) and a pigment extender, and a wherein a combined weight percent of the pigment and pigment extender is 0.4-40 wt. %. In another non-limiting embodiment, the improved coating that is substantially or fully absent TiO₂ includes a pigment (e.g., BaSO₄, ZnO, and/or ZnS) and a pigment extender, and a wherein a combined weight percent of the pigment and pigment extender is 1-20 wt. %. In another non-limiting embodiment, the improved coating that is substantially or fully absent TiO₂ includes a pigment (e.g., BaSO₄, ZnO, and/or ZnS) and a pigment extender, and a wherein a combined weight percent of the pigment and pigment extender is 5-15 wt. %. In another non-limiting embodiment, the pigment extender includes 20-100 wt. % microspheres (and all values and ranges therebetween). In another non-limiting embodiment, the pigment extender includes 60-100 wt. % microspheres (e.g., glass microspheres, ceramic microspheres, polymeric microspheres, metal microspheres, etc.). In another non-limiting embodiment, 20-100 wt. % of the microspheres (and all values and ranges therebetween) are hollow microspheres. In another non-limiting embodiment, 60-100 wt. % of the microspheres are hollow microspheres. Use of hollow microspheres has the added benefit of reducing the density of the coating as compared to a coating that is absent the hollow microspheres. A standard white coating that uses TiO₂ as the pigment and is absent hollow microspheres has a density of about 10-13 lbs./gal., and the improved coating that is absent or substantially absent TiO₂ as the pigment and includes hollow polymeric microspheres has a density of about 7-9 lbs./gal., thereby representing a 10-46% decrease in density. Such density reduction of the coating allows for a) additional pallets of pails or drums to be transported on trucks, b) increases worker safety by making the pails lighter for transport around the job site, c) reducing the surface temperature of the existing roof membrane by up to 8-12% cooler than the same a prior coating that uses TiO₂ as the pigment and is absent hollow microspheres. In another non-limiting embodiment, 20-100 wt. % of the microspheres (and all values and ranges therebetween) are polymeric microspheres. In another non-limiting embodiment, 60-100 wt. % of the microspheres are polymeric microspheres. In another non-limiting embodiment, the polymeric hollow microspheres can be used in an expanded or non-expanded form and mixtures of expanded and non-expanded microspheres can be used. In another non-limiting embodiment, the microspheres have an average particle size of 1-500 μm (and all values and ranges therebetween), and typically have an average particle size of 5-50 μm. Non-limiting microspheres that can be used include microspheres offered under the tradename Expancel™. In another non-limiting embodiment, the coating includes a pigment that is substantially or fully absent TiO₂ (e.g., BaSO₄, ZnO, and/or ZnS) and a pigment extender that includes microspheres, and a wherein a combined weight percent of the pigment and pigment extender that includes microspheres is 0.2-65 wt. % (and all values and ranges therebetween). In another non-limiting embodiment, the coating includes a pigment that is substantially or fully absent TiO₂ (e.g., BaSO₄, ZnO, and/or ZnS) and a pigment extender that includes microspheres, and a wherein a combined weight percent of the pigment and pigment extender that includes microspheres is 0.2-15 wt. %. In another non-limiting embodiment, the coating includes a pigment that is substantially or fully absent TiO₂ (e.g., BaSO₄, ZnO, and/or ZnS) and a pigment extender that includes microspheres, and a wherein a combined weight percent of the pigment and pigment extender that includes microspheres is 4-10 wt. % (and all values and ranges therebetween). In another non-limiting embodiment, the coating includes a pigment that is substantially or fully absent TiO₂ (e.g., BaSO₄, ZnO, and/or ZnS) and a pigment extender that includes microspheres, and a wherein a weight percent of the pigment is less than a weight percent of the pigment extender that includes microspheres. In another non-limiting embodiment, the weight percent ratio of in the coating of the pigment that is substantially or fully absent TiO₂ (e.g., BaSO₄, ZnO, and/or ZnS) to the pigment extender that includes microspheres is 0.05:1 to 0.8:1 (and all values and ranges therebetween). In another non-limiting embodiment, the weight percent ratio of in the coating of the pigment that is substantially or fully absent TiO₂ (e.g., BaSO₄, ZnO, and/or ZnS) to the pigment extender that includes microspheres is 0.1:1 to 0.3:1.

In another non-limiting and/or alternative aspect of the present disclosure, the improved coating that is substantially or fully absent TiO₂ includes a pigment that includes BaSO₄. In one non-limiting embodiment, BaSO₄ constitutes 50-100 wt. % (and all values and ranges therebetween) of the pigment in the coating. In another non-limiting embodiment, BaSO₄ constitutes 75-100 wt. % of the pigment in the coating.

In another non-limiting and/or alternative aspect of the present disclosure, the improved coating that is substantially or fully absent TiO₂ includes a pigment that includes BaSO₄ and ZnO at a weight ratio of 9:1 to 1:9 (and all values and ranges therebetween). In another non-limiting embodiment, the pigment of the coating that is substantially or fully absent TiO₂ includes BaSO₄ and ZnO at a weight ratio of 5:1 to 1:5. In another non-limiting embodiment, the pigment of the coating that is substantially or fully absent TiO₂ includes BaSO₄ and ZnO at a weight ratio of 3:1 to 1:3. In another non-limiting embodiment, the pigment of the coating that is substantially or fully absent TiO₂ includes BaSO₄ and ZnO at a weight ratio of 1.5:1 to 1:1.5.

In another non-limiting and/or alternative aspect of the present disclosure, the improved coating that is substantially or fully absent TiO₂ includes a pigment that includes BaSO₄ and ZnS at a weight ratio of 9:1 to 1:9 (and all values and ranges therebetween). In another non-limiting embodiment, the pigment of the coating that is substantially or fully absent TiO₂ includes BaSO₄ and ZnS at a weight ratio of 5:1 to 1:5. In another non-limiting embodiment, the pigment of the coating that is substantially or fully absent TiO₂ includes BaSO₄ and ZnS at a weight ratio of 3:1 to 1:3. In another non-limiting embodiment, the pigment of the coating that is substantially or fully absent TiO₂ includes BaSO₄ and ZnS at a weight ratio of 1.5:1 to 1:1.5.

In another non-limiting and/or alternative aspect of the present disclosure, the improved coating that is substantially or fully absent TiO₂ includes a pigment that includes BaSO₄, ZnO and ZnS, and wherein a weight ratio BaSO₄ to the combined weight of ZnO and ZnS is 9:1 to 1:9 (and all values and ranges therebetween), and the weight ratio of ZnO and ZnS is 100:1 to 1:100 (and all values and ranges therebetween). In another non-limiting embodiment, the pigment of the coating that is substantially or fully absent TiO₂ includes BaSO₄, ZnO and ZnS, and wherein a weight ratio BaSO₄ to the combined weight of ZnO and ZnS is 5:1 to 1:5, and the weight ratio of ZnO and ZnS is 25:1 to 1:25. In another non-limiting embodiment, the pigment of the coating that is substantially or fully absent TiO₂ includes BaSO₄, ZnO and ZnS, and wherein a weight ratio BaSO₄ to the combined weight of ZnO and ZnS is 3:1 to 1:3, and the weight ratio of ZnO and ZnS is 10:1 to 1:10.

In another non-limiting and/or alternative aspect of the present disclosure, the particle size of the BaSO₄, ZnO, and/or ZnS in the improved coating that is substantially or fully absent TiO₂ is 1 nanometers to 500 nanometers (and all values and ranges therebetween. In another non-limiting embodiment, there can exist blends of two or more different particle sizes of BaSO₄, ZnO, and/or ZnS in order to fill interstitial spaces and improve the hiding power of the dried film of coating material.

In another non-limiting and/or alternative aspect of the present disclosure, the improved coating that is substantially or fully absent of TiO₂ includes a) a pigment that includes one or more of BaSO₄, ZnO, and/or ZnS, and b) a secondary pigment that includes one or more of CaCO₃, SiO₂, Al₂O₃, MgO, YAlO₃, CaO, MgAl₂O₄, and/or LaAlO₃. In another non-limiting embodiment, the combined weight percent of the pigment formed of BaSO₄, ZnO, and ZnS is 0.5-50 wt. % (and all values and ranges therebetween), and the combined weight percent of the secondary pigment that includes CaCO₃, SiO₂, Al₂O₃, MgO, YAlO₃, CaO, MgAl₂O₄, and LaAlO₃, when use, is 0.1-50 wt. % (and all values and ranges therebetween). In another non-limiting embodiment, the weight ratio of the combined weight percent of BaSO₄, ZnO, and ZnS to the combined weight percent of the secondary pigment that includes CaCO₃, SiO₂, Al₂O₃, MgO, YAlO₃, CaO, MgAl₂O₄, and LaAlO₃ is 9:1 to 1:5 (and all values and ranges therebetween). In another non-limiting embodiment, the weight ratio of the combined weight percent of BaSO₄, ZnO, and ZnS to the combined weight percent of the secondary pigment that includes CaCO₃, SiO₂, Al₂O₃, MgO, YAlO₃, CaO, MgAl₂O₄, and LaAlO₃ is 9:1 to 1:2. In another non-limiting embodiment, the weight ratio of the combined weight percent of BaSO₄, ZnO, and ZnS to the combined weight percent of the secondary pigment that includes CaCO₃, SiO₂, Al₂O₃, MgO, YAlO₃, CaO, MgAl₂O₄, and LaAlO₃ is 9:1 to 1:1. In another non-limiting embodiment, the weight ratio of the combined weight percent of BaSO₄, ZnO, and ZnS to the combined weight percent of the secondary pigment that includes CaCO₃, SiO₂, Al₂O₃, MgO, YAlO₃, CaO, MgAl₂O₄, and LaAlO₃ is 9:1 to 1.1:1. In another non-limiting embodiment, the average particle size of the BaSO₄, ZnO, ZnS, CaCO₃, SiO₂, Al₂O₃, MgO, YAlO₃, CaO, MgAl₂O₄, and/or LaAlO₃ in the improved coating is 1 nanometers to 500 nanometers (and all values and ranges therebetween). In another non-limiting embodiment, the improved coating optionally includes a secondary pigment, and the secondary pigment is or includes CaCO₃, ZnS, SiO₂, Al₂O₃, MgO, CaO, and/or MgAl₂O₄. In another non-limiting embodiment, the improved coating optionally includes a secondary pigment, and the secondary pigment is or includes CaCO₃, ZnS, and/or Al₂O₃.

In another non-limiting and/or alternative aspect of the present disclosure, the coating is an acrylic-based coating or vinyl-acrylic based coating that includes an acrylic polymer. In one non-limiting embodiment, the acrylic polymer constitutes at least 20 wt. % of the coating (e.g., 20-70 wt. % and all values and ranges therebetween). In another non-limiting embodiment, the acrylic polymer constitutes 30-60 wt. % of the coating. In one non-limiting formulation, the acrylic-based coating or vinyl-acrylic based coating is or includes an acrylic polymer such as, but not limited to, Rhoplex™ EC-2540. In another non-limiting formulation, the acrylic polymer constitutes the largest weight percent component of the coating.

In another non-limiting and/or alternative aspect of the present disclosure, the coating is an acrylic-based coating or vinyl-acrylic based coating that includes an acrylic polymer, and the coating optionally includes a polymer dispersion. In one non-limiting formulation, the polymer dispersion, when used, constitutes at least 0.5 wt. % of the coating (e.g., 0.5-20 wt. % and all values and ranges therebetween). In another non-limiting formulation, the polymer dispersion, when used, has a less weight percent content in the coating than the weight percent content of the acrylic polymer. In another non-limiting formulation, the weight ratio of acrylic polymer to polymer dispersion in the coating is at least 1.5:1 (e.g., 1.5:1 to 35:1 (and all values and ranges therebetween). In another non-limiting formulation, the polymer dispersion is or includes urethane-acrylic hybrid polymer dispersion (e.g., Hybridur™ 870), PVAc homopolymers, VAE (vinyl acetate-ethylene) co-and-terpolymers, styrene-acrylate (SA)-based dispersions.

In another non-limiting and/or alternative aspect of the present disclosure, the coating optionally includes one or more of water, glycol, biocide, defoamer, dispersant, pH adjuster, fire retardant, thickener, coalescent solvent and/or filler. In one non-limiting embodiment, the water content of the coating, when used, is at least 0.5 wt. % (e.g., 0.5-25 wt. % and all values and ranges therebetween). In another non-limiting embodiment, the glycol content of the coating, when used, is at least 0.1 wt. % (e.g., 0.1-15 wt. % and all values and ranges therebetween). Non-limiting examples of glycol that can optionally be used include ethylene glycol and propylene glycol. In another non-limiting embodiment, the glycol content of the coating, when used, is at least 0.1 wt. % (e.g., 0.1-15 wt. % and all values and ranges therebetween). Non-limiting examples of glycol that can optionally be used in the coating include ethylene glycol and/or propylene glycol. In another non-limiting embodiment, the biocide content of the coating, when used, is at least 0.1 wt. % (e.g., 0.1-10 wt. % and all values and ranges therebetween). Non-limiting examples of biocide that can optionally be used in the coating include Mergal™ 851, Bioban™ 200, Rocima™ 63 and/or Polyphase™ EC 17. In another non-limiting embodiment, the defoamer content of the coating, when used, is at least 0.05 wt. % (e.g., 0.05-5 wt. % and all values and ranges therebetween). Non-limiting examples of defoamer that can optionally be used in the coating include DEE FO™ (oil-based defoamer) and/or NXZ Antifoam™. In another non-limiting embodiment, the dispersant content of the coating, when used, is at least 0.05 wt. % (e.g., 0.05-5 wt. % and all values and ranges therebetween). Non-limiting examples of dispersant that can optionally be used in the coating include potassium tripolyphosphate and/or Tamol™ 851. In another non-limiting embodiment, the pH adjuster content of the coating, when used, is at least 0.001 wt. % (e.g., 0.001-2 wt. % and all values and ranges therebetween). Non-limiting examples of pH adjuster that can optionally be used in the coating include ammonium hydroxide. In another non-limiting embodiment, the fire retardant content of the coating, when used, is at least 1 wt. % (e.g., 1-40 wt. % and all values and ranges therebetween). Non-limiting examples of fire retardant that can optionally be used in the coating include antimony trioxide (Sb₂O₃), aluminum trihydrate (ATH), and/or ammonium polyphosphate (NH₄PO₃). In additional to the fire retardant properties, antimony trioxide and/or aluminum trihydrate can optionally provide secondary pigment extender properties to the coating; however, for purposes of this disclosure, antimony trioxide and/or aluminum trihydrate is not considered a secondary pigment. In one non-limiting formulation, the total weight percent content of fire retardant in the coating can constitute the second or third largest weight percent component of the coating; however, this is not required. In another non-limiting embodiment, the particle size of the fire retardant in the improved coating is 1 nanometers to 500 nanometers (and all values and ranges therebetween). In another non-limiting embodiment, the fire retardant includes antimony trioxide. In another non-limiting embodiment, the fire retardant includes antimony trioxide and one or both of aluminum trihydrate, and/or ammonium polyphosphate. In another non-limiting embodiment, the fire retardant includes antimony trioxide and aluminum trihydrate. In another non-limiting embodiment, the fire retardant includes 1-20 wt. % antimony trioxide (and all values and ranges therebetween) and 5-35 wt. % aluminum trihydrate (and all values and ranges therebetween). In another non-limiting embodiment, the fire retardant includes antimony trioxide and aluminum trihydrate, and the weight percent of antimony trioxide is less than the weight percent of aluminum trihydrate. In another non-limiting embodiment, the thickener content of the coating, when used, is at least 0.1 wt. % (e.g., 0.1-20 wt. % and all values and ranges therebetween). Non-limiting examples of thickener that can optionally be used in the coating include organoclays, hydrogenated castor oils, fumed silicas or polyamides, cellulosics, acrylic thickeners (ASE/HASE), associative thickeners (HEUR, HMPE), and clays. In another non-limiting embodiment, the coalescent solvent in the coating, when used, is at least 0.05 wt. % (e.g., 0.05-5 wt. % and all values and ranges therebetween). Non-limiting examples of coalescent solvent that can optionally be used in the coating include texanol. In another non-limiting embodiment, the filler in the coating, when used, is at least 0.5 wt. % (e.g., 0.5-40 wt. % and all values and ranges therebetween). Non-limiting examples of filler that can optionally be used in the coating include kaolin, limestone, diatomite, talc, asbestos, mica, barite, fuller's earth (e.g., montmorillonite, etc.), pyrophyllite, and/or wollastonite.

In another non-limiting and/or alternative aspect of the present disclosure, the following formulas represent non-limiting examples of an acrylic-based improved coating that is substantially or fully absent TiO₂ in weight percent and include all values and ranges therebetween:

| | Ex. 1 | Ex. 2 |
|---|---|---|
| Component | Weight Percent | Weight Percent |
| Water | 5-30 | 8-25 |
| Glycol | 0-15 | 0.5-5 |
| Thickener | 0-5 | 0-2 |
| Defoamer | 0-5 | 0-2 |
| Dispersing Agent | 0-5 | 0-2 |
| pH Adjuster | 0-2 | 0-1 |
| BaSO₄, ZnO and/or ZnS | 0.1-50 | 0.1-30 |
| Secondary Pigment | 0-35 | 0-25 |
| Polymer base (e.g., acrylic, acrylic | 20-65 | 20-60 |
| blend, latex, vinyl-acrylic, | | |
| polyurethane, polyuria, | | |
| silicone, silicon hybrid, | | |
| polyvinyl alcohol, | | |
| polydimethylsiloxane, | | |
| PMMA, PUMA, SEBS, | | |
| Alkyd, epoxy, PVDF, etc.) | | |
| Fire Retardant | 0-55 | 5-30 |
| Biocide | 0-8 | 0-6 |
| Polymer Dispersion | 0-15 | 2-12 |
| Pigment Extender | 0.1-20 | 1-9 |
| Coalescent Solvent | 0-10 | 0-5 |
| Filler | 0-25 | 0-15 |
| | Ex. 3 | Ex. 4 |
| Component | Weight Percent | Weight Percent |
| Water | 5-30 | 9-16 |
| Thickener | 0-4 | 0-0.6 |
| Defoamer | 0-2 | 0.1-0.4 |
| Dispersing Agent | 0-1 | 0.1-0.9 |
| pH Adjuster | 0-0.5 | 0.01-0.04 |
| BaSO₄, ZnO and/or ZnS | 0.2-20 | 0.3-15 |
| Secondary Pigment (e.g., CaCO₃, | 0-20 | 0-12 |
| ZnS, SiO₂, Al₂O₃, MgO, | | |
| YAlO₃, CaO, MgAl₂O₄, | | |
| and/or LaAlO₃) | | |
| Polymer base (e.g., acrylic, acrylic | 20-65 | 30-55 |
| blend, latex, vinyl-acrylic, | | |
| polyurethane, polyuria, | | |
| silicone, silicon hybrid, | | |
| polyvinyl alcohol, | | |
| polydimethylsiloxane, | | |
| PMMA, PUMA, SEBS, | | |
| Alkyd, epoxy, PVDF, etc.) | | |
| Fire Retardant | 0-40 | 20-35 |
| Biocide | 0-5 | 0.5-3.5 |
| Polymer Dispersion | 0-15 | 1-9 |
| Pigment Extender | 1-12 | 1-10 |
| (e.g., Microspheres, etc.) | | |
| Coalescent Solvent | 0-6 | 0.2-3 |
| Filler | 0-20 | 0-12 |
| | Ex. 5 | Ex. 6 |
| Component | Weight Percent | Weight Percent |
| Water | 6-20 | 8-15 |
| Glycol | 0-8 | 1-3 |
| Thickener | 0-4 | 0-1 |
| Defoamer | 0-2 | 0.1-0.5 |
| Dispersing Agent | 0-2 | 0.1-0.8 |
| pH Adjuster | 0-0.5 | 0.01-0.1 |
| BaSO₄, ZnO and/or ZnS | 0.1-25 | 0.5-3 |
| Secondary Pigment (e.g., CaCO₃, | 0-22 | 0-2.8 |
| ZnS, SiO₂, Al₂O₃, MgO, | | |
| YAlO₃, CaO, MgAl₂O₄, | | |
| and/or LaAlO₃) | | |
| Acrylic or Acrylic Blend | 20-60 | 30-55 |
| Fire Retardant | 0-40 | 15-30 |
| Biocide | 0-6 | 0.5-3 |
| Polymer Dispersion | 0-15 | 2-8 |
| Pigment Extender | 1-10 | 2-7 |
| (e.g., Microspheres, etc.) | | |
| Coalescent Solvent | 0-9 | 0.1-2 |
| Filler | 0-10 | 0-5 |
| | Ex. 7 | Ex. 8 |
| Component | Weight Percent | Weight Percent |
| Water | 6-20 | 8-15 |
| Glycol | 0-8 | 1-3 |
| Thickener | 0-4 | 0-1 |
| Defoamer | 0-2 | 0.1-0.5 |
| Dispersing Agent | 0-2 | 0.1-0.8 |
| pH Adjuster | 0-0.5 | 0.01-0.1 |
| BaSO₄ | 0.2-5 | 0.4-1.5 |
| Secondary Pigment (e.g., CaCO₃, | 0-10 | 0-3 |
| Al₂O₃, MgO, CaO, | | |
| and/or MgAl₂O₄) | | |
| Acrylic or Acrylic Blend | 22-58 | 32-54 |
| Fire Retardant (e.g., Sb₂O₃, ATH, | 2-38 | 12-32 |
| and/or NH₄PO₃) | | |
| Biocide | 0-4 | 0.2-3 |
| Polymer Dispersion | 0-14 | 2-7 |
| Pigment Extender | 1-12 | 2-8 |
| (e.g., Microspheres, etc.) | | |
| Coalescent Solvent | 0-8 | 0.1-2 |
| Filler | 0-10 | 0-8 |

In the above examples, the above weight percent ranges include all values and ranges therebetween.

It is a principal object of the present disclosure of an improved roofing and/or siding system that has improved resulting reflectivity and/or an improved Solar Reflectance Index (SRI).

Another and/or alternative object of the present disclosure is the provision of an improved roofing and/or siding system that has improved resulting reflectivity of at least 60% and/or an improved Solar Reflectance Index (SRI) of at least 60.

Another and/or alternative object of the present disclosure is the provision of an improved roofing and/or siding system that includes one or more layers of an improved coating that is substantially or fully absent TiO₂, which improved coating is used to improve the resulting reflectivity and/or an improved Solar Reflectance Index (SRI) of the roofing and/or siding system.

Another and/or alternative object of the present disclosure is the provision of an improved roofing and/or siding system that includes one or more layers of an improved coating that is substantially or fully absent TiO₂, which improved coating can be applied to the roofing and/or siding material prior to or after the roofing and/or siding material is applied to a roof and/or side of a structure.

Another and/or alternative object of the present disclosure is the provision of an improved roofing and/or siding system that includes one or more layers of an improved coating that is substantially or fully absent TiO₂, wherein the roofing and/or siding system includes shingles, cap sheet roll roofing, modified bitumen, foam roofing, built-up roofing (BUR), metal roofing and/or siding, plastic roofing and/or siding, flood coat and gravel systems, and wood roofing and/or siding.

Another and/or alternative object of the present disclosure is the provision of an improved roofing and/or siding system that includes one or more layers of an improved coating that is substantially or fully absent TiO₂, wherein the improved coating is a solvent-based coating, a latex-based coating, an acrylic-based coating, a vinyl-acrylic based coating, a polyurethane base coating, a polyurea-based coating, a silicone-based coating, a silicon hybrid based coating, polyvinyl alcohol-based coating, polydimethylsiloxane-based coating, PMMA-based coating, PUMA-based coating, SEBS elastomeric based coating, alkyd-based coating, epoxy-based coating, or a Polyvinylidene Fluoride (PVDF) based coating.

Another and/or alternative object of the present disclosure is the provision of an improved roofing and/or siding system that includes one or more layers of an improved coating that is substantially or fully absent TiO₂, wherein the roofing and/or siding system meets one or more or all of the ASTM D6083 standard.

Another and/or alternative object of the present disclosure is the provision of an improved roofing and/or siding system that includes one or more layers of an improved coating that is substantially or fully absent TiO₂, wherein the pigment of the improved coating includes one or more of BaSO₄, ZnO, and/or ZnS.

Another and/or alternative object of the present disclosure is the provision of an improved roofing and/or siding system that includes one or more layers of an improved coating that is substantially or fully absent TiO₂, wherein the pigment of the improved coating includes one or more of BaSO₄, ZnO, and/or ZnS, and a pigment extender.

Another and/or alternative object of the present disclosure is the provision of an improved roofing and/or siding system that includes one or more layers of an improved coating that is substantially or fully absent TiO₂, wherein the pigment of the improved coating includes one or more of BaSO₄, ZnO, and/or ZnS, and a pigment extender, and wherein the pigment extender include hollow polymeric microspheres.

Another and/or alternative object of the present disclosure is the provision of an improved roofing and/or siding system that includes one or more layers of an improved coating that is substantially or fully absent TiO₂, wherein the pigment of the improved coating includes a) one or more of BaSO₄, ZnO, and/or ZnS, and b) and optionally a secondary pigment that includes one or more of CaCO₃, SiO₂, Al₂O₃, MgO, YAlO₃, CaO, MgAl₂O₄, and/or LaAlO₃.

Another and/or alternative object of the present disclosure is the provision of an improved roofing and/or siding system that includes one or more layers of an improved coating that is substantially or fully absent TiO₂, wherein the improved coating includes no more than 5 wt. % TiO₂.

Another and/or alternative object of the present disclosure is the provision of an improved roofing and/or siding system that includes one or more layers of an improved coating that is substantially or fully absent TiO₂, wherein the improved coating is an acrylic-based coating or vinyl-acrylic based coating that includes an acrylic polymer, and optionally includes a polymer dispersion.

Another and/or alternative object of the present disclosure is the provision of an improved roofing and/or siding system that includes one or more layers of an improved coating that is substantially or fully absent TiO₂, wherein the improved coating optionally includes one or more of water, glycol, biocide, defoamer, dispersant, pH adjuster, fire retardant, thickener, coalescent solvent and/or filler.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various non-limiting embodiments that the disclosure may take in physical form and in certain parts and arrangement of parts wherein:

FIG. 1 is a side sectional view of a roofing and/or siding system illustrating a layer of coating material in accordance with the present disclosure applied to the roofing and/or siding system.

FIG. 2 is a side sectional view of another roofing and/or siding system illustrating a layer solid material applied onto the layer of coating material in accordance with the present disclosure applied to the roofing and/or siding system.

FIG. 3 is a side sectional view of still another roofing and/or siding system illustrating a layer solid material applied onto the layer of coating material in accordance with the present disclosure applied to the roofing and/or siding system.

### DETAILED DESCRIPTION OF NON-LIMITING EMBODIMENTS

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

The inventors have conceived of novel technology that, for the purpose of illustration, is disclosed herein as applied in the context of an apparatus and method for metal treatment analysis. While the disclosed applications of the inventors' technology satisfy a long-felt but unmet need in the art of metal treatment analysis, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

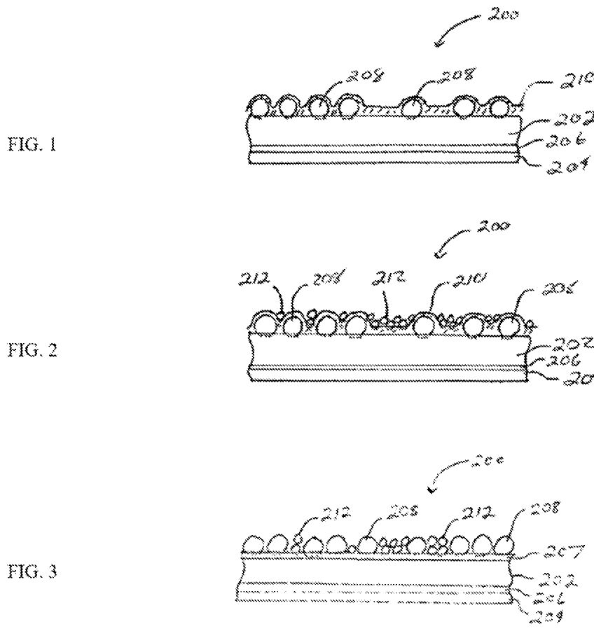

Referring now to the drawings wherein the showings are for the purpose of illustrating a non-limiting embodiments of the present disclosure only and not for the purpose of limiting same, FIG. 1 illustrates a shingle, cap sheet roll roofing material or modified bitumen roofing material 200. The roofing material 200 is configured to be secured to a roof, roof substrate (e.g., base sheets), or subroof by any suitable arrangement.

The roofing material 200 includes a bitumen- or asphalt-based material 202, 204, a reinforcement material 206 therebetween, and layer of granules or slag 208. The reinforcement material 206 is typically a felt or fiberglass material that is commonly used in the art; however, other materials can be used. The reinforcement material 206 is shown as fully embedded in the bitumen- or asphalt-based material 202; however, this is not required. The granules or slag 208 are illustrated as partially embedded and secured in the bitumen- or asphalt-based material 202. The granules or slag can be typical granules or slag used in roofing materials or highly reflective granules or slag. The granules are generally derived from a mineral base rock such as greenstone, greystone, nephylene syenite, gravel slate, gannister, granite, quartzite, andosite, rhyolite and the like. The granules may be coated to color the granules and/or provide the granules with antimicrobial resistance. The granules can be spherical and have the same size; however, this is not required. In practice, the granules have a variety of different shapes. One common size of granules used on shingles is No. 11 grade particles. No. 11 grade particles are known in the industry to have a particle range of about 8×40 US mesh having an average mesh size of about 19 US mesh (i.e., 937 mm sieve designation). The slag can have a particle size distribution of between 50 mesh and 20 mesh.

As illustrated in FIG. 1 much of the top surface of bitumen- or asphalt-based material 202 is covered by granules or slag 208. Generally, a majority of the surface of the bitumen- or asphalt-based material 202 is covered by granules or slag 208. Typically, about 90-98% of the exposed surface of bitumen- or asphalt-based material 202 is covered by granules or slag 208. The coverage provided by the granules or slag reduces the amount of exposed black surface from the bitumen- or asphalt-based material 202, thus non-black granules or slag, when used, can result in the increase the resulting or effective reflectivity or SRI of roofing material 200.

Referring again to FIG. 1, roofing material 200 includes one or more layers of a coating material 210. The coating material 210 can be applied in a single application or by multiple applications. The coating material 210 can be applied in many different ways such as, but not limited to, spray coating, dipping, pouring and subsequently spreading, etc. If more than a single application is used to apply the coating material 210, the process for applying each coating material 210 can be the same or different.

The coating material 210 is a reflective material that has a reflectivity of at least about 70% and/or a SRI of at least 70 when dry. Typically, the coating material 210 color is white; however, this is not required. The coating material 210 is shown to be applied after granules or slag 208 have been applied to the surface of bitumen- or asphalt-based material 202. The coating material 210 can be applied over the granules or slag on the jobsite after installation of the roofing material 200.

As illustrated in FIG. 1, the layer of coating material 210 at least partially coats many of granules or slag 208 and at least partially fills in the spaces between granules or slag 208. Typically, a majority of granules or slag 208 are at least partially coated with the coating material 210 and a majority of the spaces between the granules or slag are at least partially filled in by the coating material 210. The coating material 210 layer not only increases the resulting reflectivity of the roofing material, the coating material 210 layer facilitates in the binding of the granules or slag to the roofing material, increases the strength and/or durability of the roofing material, positively affects the aesthetic properties of the roofing material, and/or positively affects other properties of the roofing material.

As illustrated in FIG. 1, the thickness of the coating material 210 layer is thinner on the top surfaces of granules or slag 208 than the thickness of the coating layer between the granules or slag; however, this is not required. This varying of thickness is due in part to the viscosity of the coating material 210. FIG. 1 also illustrates that the thickness of the coating material 210 layer between granules or slag 208 is less than the height of granules or slag 208 that are extending above the surface of the bitumen- or asphalt-based material 202; however, this is not required. As such, the roofing material maintains a non-smooth texture. However, the filling of the spaces by the coating material 210 does form a smoother top surface of the roofing material. As can be appreciated, the amount of coating material 210 applied to the top of the roofing material can be controlled to a) form a smooth top surface wherein the coating material 210 layer in the spaces between the granules or slag equals or exceeds the height of granules or slag 208 that are extending above the surface of the bitumen- or asphalt-based material 202, or b) form a textured surface as shown in FIG. 1. The degree of roughness of the roofing material can be in part controlled by the thickness of the coating material 210 layer. It has been found that smoother the top surfaces of the roofing material which include a partially exposed reflective coating material 210 layer have a greater resulting or effective reflectivity than less smooth top surfaces. The thickness of the wet coating material 210 layer is typically at least about 0.5 mils (approximately 0.03 gal./100 ft²). Typically, the wet coating material 210 layer is less than about 50 mils (approximately 3.13 gal./100 ft²); however, this is not required. In one non-limiting example, the thickness of the wet coating material 210 layer from a coating material 210 having a reflectivity of at least about 70% to form a roofing material having a resulting reflectivity that exceeds about 60% is about 5-25 mils. The thickness of the dried coating material 210 layer generally depends on the amount of solids in the coating material 210.

This reflective roofing material can be formed by a manufacturing process at a site that is remote to the site that the roofing materials are to be installed. As can be appreciated, the one or more layers of coating material 210 can be applied on site just prior to or after the roof material is applied to the roof substrate. As can be appreciated, the roofing material formed by an off-site manufacturing process (e.g., prefabrication process) can be formed without having to further treat the surface of the roofing material.

The type of coating used on the roofing material is limited only to the ability of the coating material 210 to properly bind to the bitumen- or asphalt-based material 202 and/or granules or slag 208. The coating material 210 can be a water-based coating, a solvent-based coating, a latex-based coating, an acrylic-based coating, a vinyl-acrylic based coating, a polyurethane base coating, a polyurea-based coating, a silicone-based coating, a silicon hybrid based coating, polyvinyl alcohol-based coating, polydimethylsiloxane-based coating, PMMA-based coating, PUMA-based coating, SEBS elastomeric based coating, alkyd-based coating, epoxy-based coating, or a Polyvinylidene Fluoride (PVDF) based coating, and the like. Typically, the color of the coating material 210 is white or extra white; however, this is not required.

As described so far above, the roofing material is a shingle, cap sheet roll roofing material or modified bitumen roofing material. It will be appreciated that the broad concept of the present disclosure can be applied to other types of roofing systems. As can be appreciated, the concept of the present disclosure can also be used on wood, plastic or metal roofing systems. The reflective coating material 210 can be applied prior to and/or after the granules or slag are applied to the wood, plastic or metal roofing system to obtain a highly reflective roof material. This roofing material could be manufactured off-site (e.g., prefabricated). Other types of roofing systems can in the reflective coating material, namely foam roofing, built-up roofing (BUR), flood coat and gravel systems, and wood roofing and/or siding, etc.

Referring now to FIG. 2, another embodiment of roofing material 200 is illustrated. In this embodiment, the structure of the roofing material is similar to the roofing material illustrated in FIG. 1, but includes an additional layer of granules or slag 212. The upper surface of the top layer of bitumen- or asphalt-based material 202 includes two different sizes of granules or slag 208, 212. A majority of the granules or slag 208 are partially embedded in layer 202; however, this is not required. As stated above, the coating material 210 can be applied in a single application or by multiple applications. The coating material 210 can be applied in many different ways such as, but not limited to, spray coating, dipping, pouring and subsequently spreading, etc. If more than a single application is used to apply the coating material 210, the process for applying each layer can be the same or different. The coating material 210 is a reflective coating as described above. The coating material 210 is shown to be applied after granules or slag 208 have been applied to the surface of bitumen- or asphalt-based material 202. As can be appreciated, a layer of coating material 210 can additionally or alternatively be applied to the bitumen- or asphalt-based material 202 prior to applying the layer of granules or slag 208. If the coating material 210 is applied to the bitumen- or asphalt-based material 202 prior to applying the layer of granules or slag 208, the granules or slag are typically applied to the coating material 210 prior to the coating layer fully drying so as to facilitate in the adhesion of the granules or slag to the surface of the roofing material; however, this is not required. Indeed, if the granules or slag are applied after the coating material 210 has substantially or fully dried, a binder can be used to facilitate in the adhesion of the granules or slag to the top surface of the roofing material.

As illustrated in FIG. 2, the layer of coating material 210 at least partially coats many of granules or slag 208 and at least partially fills in the spaces between granules or slag 208. Typically, a majority of granules or slag 208 are at least partially coated with the coating material 210 and a majority of the spaces between the granules or slag are at least partially filled in by the coating material 210. The coating material 210 layer not only increases the resulting reflectivity and/or SRI of the roofing material, the coating material 210 facilitates in the binding of the granules or slag to the roofing material, increases the strength and/or durability of the roofing material, positively affects the aesthetic properties of the roofing material, and/or positively affects other properties of the roofing material.

As illustrated in FIG. 2, granules or slag 212 are partially embedded and/or secured in the upper surface coating material 210. As can be appreciated, some of granules or slag 212 may be fully embedded in the coating material 210 and/or not embedded in the coating material 210 to meet the desired end use of roofing material 200. Typically, granules or slag 212 are applied to coating material 210 prior to the coating material 210 fully drying; however, this is not required. When granules or slag 212 are applied prior to the coating material 210 becoming fully dried, the non-fully dried coating material 210 facilitates in the adhesion of the granules or slag to the surface of the roofing material. Indeed, if granules or slag 212 are applied after the coating material 210 has substantially or fully dried, a binder can be used to facilitate in the adhesion of the granules or slag to the top surface of the roofing material.

The inclusion of granules or slag 212 on the surface of coating material 210 provides additional overage for the roofing material. As such, the addition of granules or slag 212 assist in reflecting more sunlight off the roofing material by at least partially covering the black bitumen- or asphalt-based material 202 that still may be exposed after application of granules or slag 208 and coating material 210. These smaller granules or slag also occupy the spaces between larger granules or slag 208, thereby increasing the amount of coverage by the granules or slag of the upper surface of the roofing material. This increased amount of granule coverage not only can increase the resulting reflectivity of the roofing material, but also forms a more uniform surface of the roofing material, positively affects the physical properties of the roofing material, reduce the rate of degradation of the roofing material, reduce the surface temperature of the roofing material, extend the life of the roofing material, and/or positively affects the aesthetics of the roofing material. The increased coverage provided by granules or slag 212 can results in a 1-5% or more increase in resulting and/or effective reflectivity of the roofing material. As can be appreciated, some or all of the granules or slag that are applied to the top surface of the coating material 210 can be the same size or larger than the previously applied granules or slag; however, this is not required.

Referring now to FIG. 3, another embodiment of roofing material 200 is illustrated. In this embodiment, the structure of the roofing material is similar to the roofing material illustrated in FIGS. 1 and 2, but includes a layer of reflective coating material 207 that has been applied to the top surface of the bitumen- or asphalt-based material 202 prior to the application of granules or slag 208 and 212. The upper surface of the coating material 207 includes two different sizes of granules or slag 208, 212; however, this is not required. A majority of the granules or slag 208 are partially embedded in coating material 207; however, this is not required. As stated above, the coating material 207 can be applied in a single application or by multiple applications. The coating material 207 can be applied in many different ways such as, but not limited to, spray coating, dipping, pouring and subsequently spreading, etc. If more than a single application is used to apply the coating material 207, the process for applying each layer can be the same or different.

The material that forms coating material 207 is a reflective coating as described above with regard to coating material 210 in FIGS. 1 and 2. As can be appreciated, a layer of coating material 207 can additionally be applied after one or more granules or slag coatings have been applied to the roofing material. As can also be appreciated, the roofing material illustrated in FIGS. 1-3 can be absent granules, and the reflective coating can be used to form the top layer of the roofing material.

The reflective coating is substantially or fully absent TiO₂ (e.g., 0-2 wt. % of the reflective coating and all values and ranges therebetween). The reflective coating generally has a) a resulting reflectivity of 60-99% (and all values and ranges therebetween) as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of at least 60 in accordance with ASTM E1980. The reflective coating can be a solvent-based coating, a latex-based coating, an acrylic-based coating, a vinyl-acrylic based coating, a polyurethane base coating, a polyurea-based coating, a silicone-based coating, a silicon hybrid based coating, polyvinyl alcohol-based coating, polydimethylsiloxane-based coating, PMMA-based coating, PUMA-based coating, SEBS elastomeric based coating, alkyd-based coating, epoxy-based coating, or a Polyvinylidene Fluoride (PVDF) based coating. In one non-limiting formulation, the reflective coating is an acrylic-based coating. In another non-limiting formulation, the reflective coating is an acrylic-based coating that meets one or more or all of the ASTM D6083 standard for liquid applied acrylic coating. In one non-limiting formulation, the reflective coating includes a) a pigment that includes BaSO₄, ZnO, and/or ZnS, b) pigment extender, and c) fire retardant. In another non-limiting formulation, the reflective coating includes a) BaSO₄, b) pigment extender that includes microspheres, and c) fire retardant that includes antimony trioxide (Sb₂O₃). In another non-limiting formulation, the reflective includes a) a pigment that includes BaSO₄, and wherein the BaSO₄ constitutes 0.1-5 wt. % (and all values and ranges therebetween) of the reflective coating, b) pigment extender that includes microspheres, and wherein the microspheres constitute 1-15 wt. % (and all values and ranges therebetween) of the reflective coating, and wherein the microspheres have an average particle size of 5-50 μm, and c) fire retardant that includes antimony trioxide (Sb₂O₃), and wherein the antimony trioxide (Sb₂O₃) constitutes 1-15 wt. % (and all values and ranges therebetween) of the reflective coating. In another non-limiting formulation, the weight percent ratio in the reflective coating of the pigment that is substantially or fully absent TiO₂ (e.g., BaSO₄, ZnO, and/or ZnS) to the pigment extender that includes microspheres is 0.08:1 to 0.4:1 (and all values and ranges therebetween). In another non-limiting formulation, the weight percent ratio in the reflective coating of the pigment that is substantially or fully absent TiO₂ (e.g., BaSO₄) to the microspheres is 0.09:1 to 0.35:1 (and all values and ranges therebetween). In another non-limiting formulation, the weight percent ratio in the reflective coating of antimony trioxide (Sb₂O₃) to the pigment extender that includes microspheres is 0.3:1 to 1:0.3 (and all values and ranges therebetween). In another non-limiting formulation, the weight percent ratio in the reflective coating of antimony trioxide (Sb₂O₃) to the microspheres is 0.35:1 to 1:0.35 (and all values and ranges therebetween). In another non-limiting formulation, the combined weight percent of BaSO₄, microspheres and antimony trioxide (Sb₂O₃) in the reflective coating is 5-30 wt. % (and all values and ranges therebetween). In another non-limiting formulation, the reflective coating that includes 0-1 wt. % TiO₂ (and all values and ranges therebetween) in weight percent:

| | Ex. A | Ex. B |
|---|---|---|
| Component | wt. % | wt. % |
| Water | 5-20 | 7-15 |
| Glycol | 0-9 | 0-3 |
| Thickener | 0-5 | 0-1.5 |
| Defoamer | 0-2.5 | 0-0.6 |
| Dispersing Agent | 0-2.5 | 0-0.9 |
| pH Adjuster | 0-0.6 | 0-0.15 |
| BaSO₄ | 0.15-5.5 | 0.35-1.8 |
| Secondary Pigment (e.g., CaCO₃, | 0-9 | 0-4 |
| Al₂O₃, MgO, CaO, and/or | | |
| MgAl₂O₄) | | |
| Acrylic or Acrylic Blend | 21-59 | 30-55 |
| Fire Retardant (e.g., Sb₂O₃, ATH, | 1-38 | 10-34 |
| and/or NH₄PO₃) | | |
| Biocide | 0-4.5 | 0-3 |
| Polymer Dispersion | 0-15 | 0-7 |
| Pigment Extender | 1-15 | 2-9 |
| (e.g., Microspheres, etc.) | | |
| Coalescent Solvent | 0-7 | 0-2 |
| Filler | 0-12 | 0-7 |

One non-limiting manufacturing process for forming a reflective shingle, cap sheet, or modified bitumen is described below. The reflective coating material 207 can be applied as a restoration coating to an existing fastened new or aged roof. The existing roof may or may not have a granule or slag surface. The existing roof may or may not already be coated with a previously applied reflective or non-reflective coating. The previously applied coating does not need to be of the same chemical make up as the reflective coating material 207. Once it is determined that the existing roof is a candidate to be coated with the restoration reflective coating, the coating material 207 can be applied in many different ways such as, but not limited to, spray coating, dipping, pouring and subsequently spreading, etc. Application can be in a single coat or multiple coats applied either the same way or with different application methods.

In another non-limiting manufacturing process for forming a reflective shingle, cap sheet roll roofing or modified bitumen is described below. Reinforcement material is passed through a coater containing liquid asphalt-bituminous composition to at least partially or fully impregnate the reinforcement material. The speed at which the reinforcement material is moved is about 1-100 ft./min., and typically about 20-60 ft./min; however, other speeds can be used. As the reinforcement material is passed through a coater 230, the reinforcement material is guided by one or more guide rollers, and a continuous hot asphalt-bituminous coated strip is formed. As can be appreciated, other processes can be used to coat the reinforcement material with the asphalt-bituminous composition. As can also be appreciated, more than one coating of asphalt-bituminous composition can be applied to the reinforcement material. The coated strip can optionally be passed beneath a hopper which applies granules or slag (primary granules or slag) on the upper surface of the coated strip. As can be appreciated, many different types of devices can be used to control the spread pattern and/or amount of granules or slag being applied to the coated strip, when granules or slag are used. The amount of granules or slag deposited on the upper surface of the coated strip is typically selected to cover most of the upper surface of the coated strip; however, this is not required. The coverage of granules or slag on the upper surface of the coated strip is generally represented by the coverage of granules or slag 208 in FIG. 1. For instance, when No. 11 grade granules are used, the coverage provided by the granules or slag is typically about 90-98% (ASTM D6225).

After granules or slag have been deposited on the upper surface of the asphalt-bituminous coated strip, one or more layers of a reflective coating material 208 is applied by one or more sprayers on the top surface of the coated strip. As can be appreciated, the coating material 208 can be applied to the coated strip by other processes. The coating material 208 can optionally be fast drying coating that typically takes less than 60 minutes to dry to touch; however, this is not required. A heating or drying mechanism (e.g., air blower, oven, heating coils, etc.) can optionally be used to obtain faster dry times for the coating material 208. The thickness of the one or more wet coating material 208 is generally about 0.5-100 mils (0.3-60 mils dry), and typically about 3-40 mils (1.5-24 mils dry).

After the coating material 208 is applied to the coated strip, secondary granules or slag can be optionally deposited on the surface of the coating material 208 as illustrated in FIG. 2. Typically, the granules or slag are applied to the coating material 208 prior to the coating material 208 being fully dried so as to facilitate in the adhesion of the granules or slag to the roofing material. The secondary granules or slag, when used, can optionally have a smaller average particle size than the particle size of the primary granules or slag.

After the granules or slag are deposited on the roofing material, the coated strip is typically passed around a drum; however, this is not required. As the coated strip travels about drum, some or all of the granules or slag can be at least partially pressed into the coating material 208; however, this is not required. The drum can be a heated drum to facilitate in the dry of the coating layer; however, this is not required. After the coated strip passes around drum, the coated strip can be guided by one or more guide rollers to a cooling section and/or pressing section. The cooling process is not required. One or more press rollers can be used to at least partially press granules or slag into the coating material 208 for improved adhesion of granules or slag to the roofing material; however, this is not required. After the coated strip is cooled and/or pressed, the coated strip can be rolled up and/or formed into shingles. The process steps of cooling, pressing, rolling, and shingle formation are well known in the art, thus will not be described herein.

In another non-limiting manufacturing process, the reinforcement material can be partially or fully impregnated with an asphalt-bituminous composition as discussed above. After the one or more coatings of asphalt-bituminous composition are applied to the reinforcement material, one or more layers of a reflective coating material 207 is applied by one or more sprayers on the top surface of the coated strip to form a coated strip as illustrated in FIG. 3. This application of a layer of coating material 207 on the top of the asphalt-bituminous composition is an optional process. As can be appreciated, the reflective coating material 207 can be applied to the coated strip by other processes. The coating layer can be atomized during the spraying process obtain a more uniform coating; however, this is not required. After the one or more coatings of the coating material 207 has been applied to the top surface of the asphalt-bituminous composition, the coated strip can optionally be passed beneath a hopper which optionally applies granules or slag on the upper surface of the coated strip. The strip can optionally be further processed by drying, passed about a drum, passed through press rollers, cooled, etc. as discussed above. After granules or slag have been deposited on the upper surface of the coated strip, one or more layers of a reflective coating material 207 can optionally be applied by one or more sprayers on the top surface of the coated strip.

After the coated strip is cooled and/or pressed, the asphalt-bituminous coated strip is rolled up and/or formed into shingles. The process steps of cooling, pressing, rolling, and shingle formation are well known in the art, thus will not be described herein.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

The description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

1. A method of forming a roofing and/or siding material comprising:
a) providing a substrate member that forms at least part of a roofing system of a structure or is configured to subsequently be used as at least part of a roofing system of a structure; said substrate member has a top surface; and
b) applying a layer of coating material to said top surface of said substrate member; said coating material including a water-based coating, a solvent-based coating, a latex-based coating, an acrylic-based coating, a vinyl-acrylic based coating, a polyurethane base coating, a polyurea-based coating, a silicone-based coating, a silicon hybrid based coating, polyvinyl alcohol-based coating, polydimethylsiloxane-based coating, PMMA-based coating, PUMA-based coating, SEBS elastomeric based coating, alkyd-based coating, epoxy-based coating, or a polyvinylidene fluoride (PVDF) based coating; said coating material includes less than 10 wt. % titanium dioxide; said coating material satisfies the requirements under ASTM D6083; said coating material has an average resulting reflectively in a dried state of at least 60% or an SRI of at least 60; said coating material includes a pigment and a pigment extender; said pigment includes of BaSO₄, ZnO, and/or ZnS; said pigment extender includes microspheres.

2. The method as defined in claim 1, wherein said coating material includes a fire retardant; said fire retardant includes antimony trioxide (Sb₂O₃), aluminum trihydrate (ATH), and/or ammonium polyphosphate (NH₄PO₃).

3. The method as defined in claim 1, wherein a top surface of said substrate member and/or a top surface of said coating material includes granules or slag.

4. The method as defined in claim 1, wherein said substrate material is a prefabricated material.

5. The method as defined in claim 1, wherein said BaSO₄, ZnO, and/or ZnS constitutes 50-100 wt. % of said pigment.

6. The method as defined in claim 1, wherein said pigment includes BaSO₄ and ZnO at a weight ratio of 9:1 to 1:9.

7. The method as defined in claim 1, wherein said pigment includes BaSO₄ and ZnS at a weight ratio of 9:1 to 1:9.

8. The method as defined in claim 1, wherein said pigment includes BaSO₄, ZnO and ZnS; a weight ratio of BaSO₄ to the combined weight of ZnO and ZnS is 9:1 to 1:9; and a weight ratio of ZnO and ZnS is 100:1 to 1:100.

9. The method as defined in claim 1, wherein coating material includes a secondary pigment that includes one or more of CaCO₃, SiO₂, Al₂O₃, MgO, YAlO₃, CaO, MgAl₂O₄, Al(OH)₃, and/or LaAlO₃.

10. The method as defined in claim 9, wherein a weight ratio of the combined weight percent of BaSO₄, ZnO, and ZnS to a combined weight percent of CaCO₃ SiO₂, Al₂O₃, MgO, YAlO₃, CaO, MgAl₂O₄, Al(OH)₃, and LaAlO₃ is 9:1 to 1:5.

11. The method as defined in claim 9, wherein said secondary pigment has an average particle size of 1 nanometer to 500 nanometers.

12. The method as defined in claim 1, wherein said pigment constitutes at least 0.5 wt. % of said coating material.

13. The method as defined in claim 1, wherein said pigment has an average particle size of 1 nanometer to 500 nanometers.

14. The method as defined in claim 2, wherein said fire retardant includes antimony trioxide (Sb₂O₃).

15. The method as defined in claim 1, wherein said coating material includes by weight percent:

| Component | Weight Percent |
|---|---|
| Water | 5-30 |
| Glycol | 0-15 |
| Thickener | 0-5 |
| Defoamer | 0-5 |
| Dispersing Agent | 0-5 |
| pH Adjuster | 0-2 |
| BaSO4, ZnO and/or ZnS | 0.5-50 |
| Secondary Pigment | 0-35 |
| Polymer Base | 20-65 |
| Fire Retardant | 0-55 |
| Biocide | 0-8 |
| Polymer Dispersion | 0-15 |
| Pigment Extender | 0.1-20 |
| Coalescent Solvent | 0-10 |
| Filler | 0.1-25. |

16. The method as defined in claim 1, wherein said coating materials includes by weight percent:

| Component | Weight Percent |
|---|---|
| Water | 8-25 |
| Glycol | 0.5-5 |
| Thickener | 0-2 |
| Defoamer | 0-2 |
| Dispersing Agent | 0-2 |
| pH Adjuster | 0-1 |
| BaSO4, ZnO and/or ZnS | 0.1-30 |
| Secondary Pigment that includes | 0-25 |
| one or more of CaCO₃, | |
| SiO₂, Al₂O₃, MgO, YAlO₃, | |
| CaO, MgAl₂O₄, Al(OH)₃, | |
| and/or LaAlO₃ | |
| Acrylic or Acrylic Blend | 20-60 |
| Fire Retardant | 0.05-30 |
| Biocide | 0-6 |
| Polymer Dispersion | 2-12 |
| Pigment Extender that includes | 1-9 |
| microspheres | |
| Coalescent Solvent | 0-5 |
| Filler | 0-15. |

17. The method as defined in claim 1, wherein said coating materials includes by weight percent:

| Component | Weight Percent |
|---|---|
| Water | 5-30 |
| Glycol | 0-10 |
| Thickener | 0-4 |
| Defoamer | 0-2 |
| Dispersing Agent | 0-1 |
| pH Adjuster | 0-0.5 |
| BaSO4, ZnO and/or ZnS | 0.2-20 |
| Secondary Pigment that includes | |
| one or more of CaCO₃, | |
| SiO₂, Al₂O₃, MgO, YAlO₃, | |
| CaO, MgAl₂O₄, Al(OH)₃, | |
| and/or LaAlO₃ | |
| Acrylic or Acrylic Blend | 20-65 |
| Fire Retardant that includes | 0.05-40 |
| antimony trioxide | |
| Biocide | 0-5 |
| Polymer Dispersion | 0-15 |
| Pigment Extender that includes | 1-12 |
| microspheres | |
| Coalescent Solvent | 0-6 |
| Filler | 0-20. |

18. The method as defined in claim 1, wherein said coating materials includes by weight percent:

| Component | Weight Percent |
|---|---|
| Water | 9-16 |
| Glycol | 1.5-2.5 |
| Thickener | 0-0.6 |
| Dispersant | 0.1-0.4 |
| Defoamer | 0.1-0.3 |
| Dispersing Agent | 0.1-0.9 |
| pH Adjuster | 0.01-0.04 |
| BaSO4, ZnO and/or ZnS | 0.5-15 |
| Secondary Pigment that includes | |
| one or more of CaCO₃, | |
| SiO₂, Al₂O₃, MgO, YAlO₃, | |
| CaO, MgAl₂O₄, Al(OH)₃, | |
| and/or LaAlO₃ | |
| Acrylic or Acrylic Blend | 30-35 |
| Fire Retardant that includes | 10-35 |
| antimony trioxide | |
| Biocide | 0.5-3.5 |
| Polymer Dispersion | 1-9 |
| Pigment Extender that includes | 1-10 |
| hollow polymeric | |
| microspheres | |
| Coalescent Solvent | 0.2-3 |
| Filler | 0-12. |

19. A roofing material and/or siding material comprising a substrate member that has a top surface and a layer of coating material on said top surface; said coating material including a water-based coating, a solvent-based coating, a latex-based coating, an acrylic-based coating, a vinyl-acrylic based coating, a polyurethane base coating, a polyurea-based coating, a silicone-based coating, a silicon hybrid based coating, polyvinyl alcohol-based coating, polydimethylsiloxane-based coating, PMMA-based coating, PUMA-based coating, SEBS elastomeric based coating, alkyd-based coating, epoxy-based coating, or a Polyvinylidene Fluoride (PVDF) based coating, and the like; said coating material includes less than 10 wt. % titanium dioxide; said coating material satisfies the requirements under ASTM D6083; said coating material has an average resulting reflectively in a dried state of at least 60% or an SRI of at least 60; said coating material includes a pigment and a pigment extender; said pigment includes of BaSO₄, ZnO, and/or ZnS; said pigment extender includes microspheres.

20. The roofing material and/or siding material as defined in claim 19, wherein said coating material includes a fire retardant; said fire retardant includes antimony trioxide (Sb₂O₃), aluminum trihydrate (ATH), and/or ammonium polyphosphate (NH₄PO₃).

21. The roofing material and/or siding material as defined in claim 19, wherein a top surface of said substrate member and/or a top surface of said coating material includes granules or slag.

22. The roofing material and/or siding material as defined in claim 19, wherein said roofing and/or siding material is a prefabricated material.

23. The roofing material and/or siding material as defined in claim 19, wherein said BaSO₄, ZnO, and/or ZnS constitutes 50-100 wt. % of said pigment.

24. The roofing material and/or siding material as defined in claim 19, wherein said pigment includes BaSO₄ and ZnO at a weight ratio of 9:1 to 1:9.

25. The roofing material and/or siding material as defined in claim 19, wherein said pigment includes BaSO₄ and ZnS at a weight ratio of 9:1 to 1:9.

26. The roofing material and/or siding material as defined in claim 19, wherein said pigment includes BaSO₄, ZnO and ZnS; a weight ratio of BaSO₄ to the combined weight of ZnO and ZnS is 9:1 to 1:9; and a weight ratio of ZnO and ZnS is 100:1 to 1:100.

27. The roofing material and/or siding material as defined in claim 19, wherein coating material includes a secondary pigment that includes one or more of CaCO₃, SiO₂, Al₂O₃, MgO, YAlO₃, CaO, MgAl₂O₄, Al(OH)₃, and/or LaAlO₃.

28. The roofing material and/or siding material as defined in claim 27, wherein a weight ratio of the combined weight percent of BaSO₄, ZnO, and ZnS to a combined weight percent of CaCO₃, SiO₂, Al₂O₃, MgO, YAlO₃, CaO, MgAl₂O₄, Al(OH)₃, and LaAlO₃ is 9:1 to 1:5.

29. The roofing material and/or siding material as defined in claim 27, wherein said secondary pigment has an average particle size of 1 nanometer to 500 nanometers.

30. The roofing material and/or siding material as defined in claim 19, wherein said pigment constitutes at least 0.5 wt. % of said coating material.

31. The roofing material and/or siding material as defined in claim 19, wherein said pigment has an average particle size of 1 nanometer to 500 nanometers.

32. The roofing material and/or siding material as defined in claim 19, wherein said fire retardant includes antimony trioxide (Sb₂O₃).

33. The roofing material and/or siding material as defined in claim 19, wherein said coating material includes by weight percent:

| Component | Weight Percent |
|---|---|
| Water | 5-30 |
| Glycol | 0-15 |
| Thickener | 0-5 |
| Defoamer | 0-5 |
| Dispersing Agent | 0-5 |
| pH Adjuster | 0-2 |
| BaSO4, ZnO and/or ZnS | 0.5-50 |
| Secondary Pigment | 0-35 |
| Polymer Base | 20-65 |
| Fire Retardant | 0-55 |
| Biocide | 0-8 |
| Polymer Dispersion | 0-15 |
| Pigment Extender | 0.1-20 |
| Coalescent Solvent | 0-10 |
| Filler | 0.1-25. |

34. The roofing material and/or siding material as defined in claim 19, wherein said coating materials includes by weight percent:
Weight Percent

| Component | Weight |
|---|---|
| Water | 8-25 |
| Glycol | 0.5-5 |
| Thickener | 0-2 |
| Defoamer | 0-2 |
| Dispersing Agent | 0-2 |
| pH Adjuster | 0-1 |
| BaSO4, ZnO and/or ZnS | 0.1-30 |
| Secondary Pigment that includes | 0-25 |
| one or more of CaCO₃, | |
| SiO₂, Al2O₃, MgO, YAlO₃, | |
| CaO, MgAl₂O₄, Al(OH)₃, | |
| and/or LaAlO₃ | |
| Acrylic or Acrylic Blend | 20-60 |
| Fire Retardant | 0.05-30 |
| Biocide | 0-6 |
| Polymer Dispersion | 2-12 |
| Pigment Extender that includes | 1-9 |
| microspheres | |
| Coalescent Solvent | 0-5 |
| Filler | 0-15. |

35. The roofing material and/or siding material as defined in claim 19, wherein said coating materials includes by weight percent:

| Component | Weight Percent |
|---|---|
| Water | 5-30 |
| Glycol | 0-10 |
| Thickener | 0-4 |
| Defoamer | 0-2 |
| Dispersing Agent | 0-1 |
| pH Adjuster | 0-0.5 |
| BaSO4, ZnO and/or ZnS | 0.2-20 |
| Secondary Pigment that includes | 0-20 |
| one or more of CaCO₃, | |
| SiO₂, Al₂O₃, MgO, YAlO₃, | |
| CaO, MgAl₂O₄, Al(OH)₃, | |
| and/or LaAlO₃ | |
| Acrylic or Acrylic Blend | 20-65 |
| Fire Retardant that includes | 0.05-40 |
| antimony trioxide | |
| Biocide | 0-5 |
| Polymer Dispersion | 0-15 |
| Pigment Extender that includes | 1-12 |
| microspheres | |
| Coalescent Solvent | 0-6 |
| Filler | 0-20. |

36. The roofing material and/or siding material as defined in claim 19, wherein said coating materials includes by weight percent:

| Component | Weight Percent |
|---|---|
| Water | 9-16 |
| Glycol | 1.5-2.5 |
| Thickener | 0-0.6 |
| Dispersant | 0.1-0.4 |
| Defoamer | 0.1-0.3 |
| Dispersing Agent | 0.1-0.9 |
| pH Adjuster | 0.01-0.04 |
| BaSO4, ZnO and/or ZnS | 0.5-15 |
| Secondary Pigment that includes | 0-12 |
| one or more of CaCO₃, | |
| SiO₂, Al₂O₃, MgO, YAlO₃, | |
| CaO, MgAl₂O₄, Al(OH)₂, | |
| and/or LaAlO₃ | |
| Acrylic or Acrylic Blend | 30-35 |
| Fire Retardant that includes | 10-35 |
| antimony trioxide | |
| Biocide | 0.5-3.5 |
| Polymer Dispersion | 1-9 |
| Pigment Extender that includes | 1-10 |
| hollow polymeric | |
| microspheres | |
| Coalescent Solvent | 0.2-3 |
| Filler | 0-12. |

37. A roofing material and/or siding material comprising a substrate member that has a top surface and a layer of coating material on said top surface; said coating material is selected from the group consisting of an acrylic-based coating and a vinyl-acrylic based coating; said coating material includes less than 5 wt. % titanium dioxide; said coating material satisfies the requirements under ASTM D6083 for a Type I and/or a Type II acrylic coating; said coating material has an average resulting reflectively in a dried state of at least 60% or an SRI of at least 60; said coating material includes pigment, pigment extender and fire retardant; said pigment includes of BaSO₄, ZnO, and/or ZnS; said pigment constitutes 0.1-50 wt. % of said coating material; said pigment extender includes microspheres; a combined weight percent of said pigment and said pigment extender in said coating material is 0.2-65 wt. %; said fire retardant includes antimony trioxide (Sb₂O₃), aluminum trihydrate (ATH), and/or ammonium polyphosphate (NH₄PO₃); said fire retardant constitutes 1-40 wt. % of said coating material.

38. The roofing material and/or siding material as defined in claim 37, wherein said BaSO₄, ZnO, and/or ZnS constitutes 50-100 wt. % of said pigment.

39. The roofing material and/or siding material as defined in claim 37, wherein coating material includes a secondary pigment; said secondary pigment includes one or more of CaCO₃, SiO₂, Al₂O₃, MgO, YAlO₃, CaO, MgAl₂O₄, Al(OH)₃, and/or LaAlO₃; said pigment has an average particle size of 1 nanometer to 500 nanometers; said secondary pigment has an average particle size of 1 nanometer to 500 nanometers.

40. The roofing material and/or siding material as defined in claim 38, wherein coating material includes a secondary pigment; said secondary pigment includes one or more of CaCO₃, SiO₂, Al₂O₃, MgO, YAlO₃, CaO, MgAl₂O₄, Al(OH)₃, and/or LaAlO₃; said pigment has an average particle size of 1 nanometer to 500 nanometers; said secondary pigment has an average particle size of 1 nanometer to 500 nanometers.

41. The roofing material and/or siding material as defined in claim 37, wherein said coating material includes by weight percent:

| Component | Weight Percent |
|---|---|
| Water | 5-30 |
| BaSO4, ZnO and/or ZnS | 0.2-20 |
| Secondary Pigment that includes | 0-20 |
| one or more of CaCO₃, | |
| SiO₂, Al₂O₃, MgO, YAlO₃, | |
| CaO, MgAl₂O₄, Al(OH)₃, | |
| and/or LaAlO₃ | |
| Acrylic or Acrylic Blend | 20-65 |
| Fire Retardant | 1-40. |

42. The roofing material and/or siding material as defined in claim 40, wherein said coating material includes by weight percent:

| Component | Weight Percent |
|---|---|
| Water | 5-30 |
| BaSO4, ZnO and/or ZnS | 0.2-20 |
| Secondary Pigment that includes | 0-20 |
| one or more of CaCO₃, | |
| SiO₂, Al₂O₃, MgO, YAlO₃, | |
| CaO, MgAl₂O₄, Al(OH)₃, | |
| and/or LaAlO₃ | |
| Acrylic or Acrylic Blend | 20-65 |
| Fire Retardant | 1-40. |
